(19) United States
(12) Patent Application Publication
(10) Pub. No.: US 2016/0147521 A1
(43) Pub. Date: May 26, 2016

(54) SYSTEM FOR DETECTING COMPONENTS OF A VEHICLE

(71) Applicant: ROBERT BOSCH GMBH, Stuttgart (DE)

(72) Inventor: Felix Hieronymi, Moeglingen (DE)

(21) Appl. No.: 14/899,287

(22) PCT Filed: Apr. 30, 2014
(86) PCT No.: PCT/EP2014/058930

§ 371 Date: Dec. 17, 2015

(30) Foreign Application Priority Data
Jun. 26, 2013 (DE) 102013212351.5

(51) Int. Cl. G06F 9/445; H04L 29/08

(52) U.S. Cl. CPC G06F 8/61; H04L 67/12; H04L 67/34

(57) ABSTRACT

System for detecting components (41, 42, 43, 44) of a vehicle (2), in particular of a motor vehicle, which comprises at least one component (41, 42, 43, 44), having at least one memory element (51, 52, 53, 54) which can be read in a wireless manner and is associated with at least one component (41, 42, 43, 44) of the vehicle (2); at least one data reading apparatus (6) which can be arranged in the vehicle (2) in particular and which is designed in order to read data which is stored in the at least one memory element (51, 52, 53, 54) in a wireless manner; and at least one transmission apparatus (8) which can be arranged in the vehicle (2) in particular and which is designed in order to transmit the data which is read from the at least one data reading apparatus (6) to at least one receiving apparatus (12).

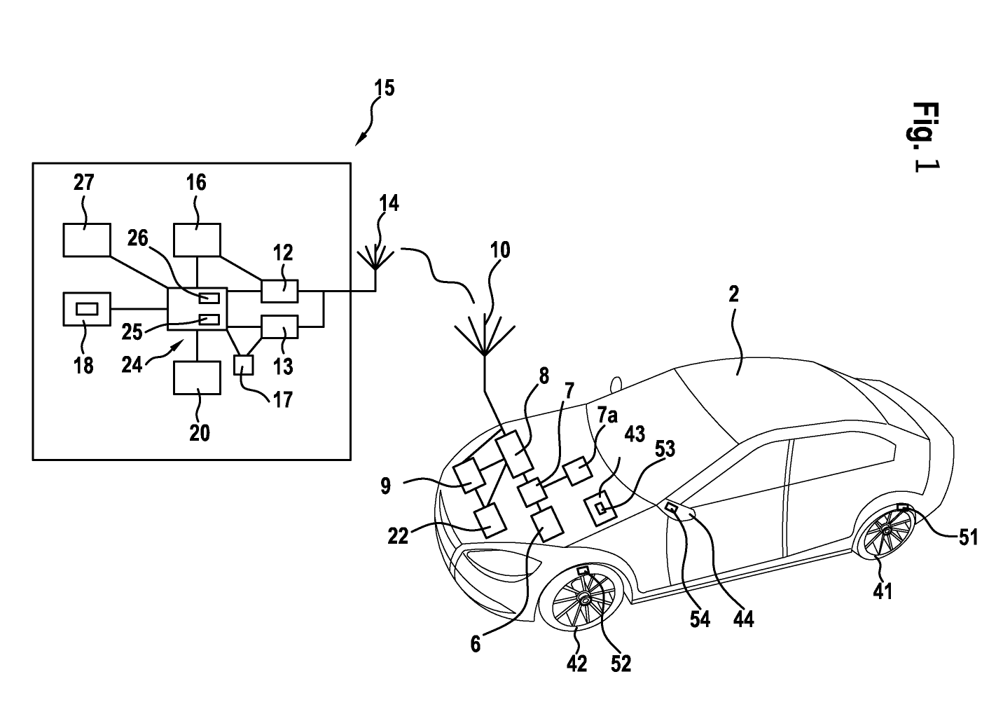

### TECHNICAL FIELD

In a (motor) vehicle, many different, in part complex components are installed to form a total system. Most, in particular the important, components have an optical identification code (e.g. Q codes, bar codes, stamped serial numbers, etc.), which contains a type of unambiguous serial number or, respectively, an identifier. If the components (such as, e.g., an injector) are installed in the vehicle, the serial number often cannot be read or only with a great amount of difficulty in order to identify the relevant component. When replacing components, the serial numbers thereof are also frequently not detected so that the complete component configuration of the vehicle can no longer be reconstructed or only with a great deal of effort.

It is also frequently unknown with regard to an individual component as to where, when and how said component was installed and used. This information is, for example, important with regard to warranty claims, field observation activities, in particular for the derivation of system design and layout, and retreading for reuse. The exact installation position, e.g. which injector is installed in which cylinder, is also often unknown, such information being, e.g., useful during an engine diagnosis.

### SUMMARY

It is therefore an aim of the invention to provide a system which enables items of information about the configuration of a (motor) vehicle, in particular the use and the installation location of components used in the vehicle, to be made available in a simple, reliable and quick manner.

A system according to the invention for detecting a component configuration of a vehicle, which comprises the type, number and/or identity of the components installed in the vehicle, has at least one memory element which can be read in a wireless manner and which is associated with at least one vehicle component, at least one data reading apparatus which can be arranged particularly in or on a vehicle and which is designed to read data which is stored in the at least one memory element in a wireless manner and at least one vehicle transmission apparatus which can be arranged particularly in a vehicle and which is designed to transmit the data which is read from the data reading apparatus to at least one suitable receiving apparatus. The data reading apparatus and the vehicle transmission apparatus can be installed in the vehicle, particularly in a fixed manner.

The invention also comprises a method for detecting components of a vehicle, in particular of a motor vehicle, which comprises at least one component with which a memory element that can be read in a wireless manner is associated. The method includes reading data in a wireless manner from the at least one memory element and transmitting the read data to at least one receiving apparatus.

On the basis of the data transmitted to the receiving apparatus, the type, the number and/or the identity of the components installed in the vehicle can be identified and, in particular, the total configuration of the vehicle including the components installed in said vehicle can be detected.

In addition, the system also comprises an evaluation apparatus which is designed to evaluate the data transmitted to the receiving apparatus in order to determine the type, number and/or identity of the components installed in the vehicle and, if applicable, to display these items of information on a display device.

In particular, the system has at least one memory apparatus which is designed to store component identification data sets, which are associated in each case with one component, and a comparison unit which is designed to compare the data transmitted to the receiving apparatus with data which are contained in the component identification data sets and thus to identify a component identification data set which contains data that coincides with the data transmitted to the receiving apparatus in order, in this way, to determine the type, number and/or identity of the components installed in the vehicle.

In one embodiment, the evaluation apparatus also additionally has a configuration comparison apparatus which is designed to compare the current configuration of a vehicle with a configuration of the same vehicle stored at an earlier point in time and to detect and, if applicable, display possible changes in the configuration of the vehicle.

By using a system according to the invention, the total configuration of the components in the vehicle can be documented at any time and can only be intentionally manipulated or inadvertently changed without notice with a great deal of effort. A “manual” detection of the components installed in the vehicle that is required particularly for test and/or trial stages is eliminated. The effort associated therewith and possible detection and transmission errors can be avoided.

In a preferred embodiment, the receiving apparatus which is designed to receive data transmitted by the vehicle transmission apparatus is a constituent part of the system.

In a further preferred embodiment, the receiving apparatus is connected to and/or equipped with a further memory apparatus which is designed to store the data received by the receiving apparatus. In this way, a current memory map of the configuration of the vehicle can always be held available, which can be accessed as required at any time.

In one embodiment, the system comprises at least one passive memory element which can be read in a wireless manner and does not have a separate energy source. Passive memory elements can be implemented in a particularly cost effective manner, can be easily installed and require little servicing. This is due to the fact that said elements do not require a separate energy supply which has to be regularly monitored and if need be charged or replaced. RFID elements, which can be obtained on the market at low prices, have especially stood the test as passive memory elements.

In order to read such an RFID element, the receiving apparatus generates a high-frequency alternating electromagnetic field, to which the RFID element is subjected. The high-frequency energy absorbed by the RFID element from the alternating electromagnetic field is used as the energy supply for the data transmission.

The alternating electromagnetic field activates a microchip present in the RFID tag which decodes the commands sent from the receiving apparatus. The response encodes and modulates the RFID element into the irradiated electromagnetic field by means of field weakening in the contactless short circuit or anti-phase reflection of the field emitted by the receiving apparatus. In this way, the RFID element transmits, for example, its own serial number, further data about the identified object and/or other items of information requested by the reading apparatus. The RFID element does not itself generate an electromagnetic field but rather influences the electromagnetic field that has been produced by the receiving apparatus.

Alternatively or additionally, the system can also comprise at least one active memory element which is equipped with a separate energy source and a transmission unit which can be activated by an external electromagnetic field and is designed to be used itself as a transmitter for an electromagnetic field. In comparison to passive memory elements, active memory elements can be read from a greater distance.

The memory elements can also be designed in a “semi-active” manner. In the case of semi-active tags, a separate energy source of the memory element takes on the supply of the microchip in which the data are stored; however, the data transmission takes place as previously described for an RFID element.

In one embodiment, the system additionally has a transmission apparatus disposed outside of the vehicle and a vehicle receiving apparatus which can be disposed in the vehicle. Such a system makes it possible to additionally transmit data from the outside, e.g. from a server, to the vehicle.

In this way, the vehicle control unit or respectively the engine control unit, can be adapted or reprogrammed particularly after new components have been installed in the vehicle and have been identified by the system in order to adapt the vehicle or engine control unit to the new components.

To this end, an optimal control unit software for the current component configuration can be determined on the basis of the component configuration of the vehicle that was ascertained by the evaluation apparatus and transmitted from a software memory, in which the control unit software is stored, via the transmission apparatus and the vehicle receiving apparatus to the vehicle, in particular the vehicle control unit, and be inputted into the vehicle control unit. Hence, the vehicle and in particular the engine of the vehicle can always be operated with a vehicle control unit which is optimally adapted to the current component configuration of the vehicle.

The software can be updated if the component configuration of the vehicle, i.e. particularly the type, number and/or identity of the components installed in the vehicle, has changed as well as if a new up-dated software is available in the software memory of the workshop system for the combination of the components currently installed in the vehicle.

In one embodiment, the transmission and receiving apparatuses are designed to transmit data with the aid of infrared radiation or with the use of a radio network, such as, e.g., a mobile radio network, WLAN, Bluetooth® and/or the internet. Mobile radio networks, WLAN, Bluetooth® and/or the internet provide proven and cost effective networks which are suitable for data transmission.

The invention also comprises a vehicle equipped with a system according to the invention, wherein at least one component is provided with at least one memory element and at least one data reading apparatus and at least one vehicle sending apparatus are fixedly installed in the vehicle.

The system can especially be set up in such a manner that data can be read from the memory elements present in the vehicle and be transmitted by the transmission apparatus when starting and/or stopping the vehicle or, respectively, the engine thereof. This procedure can take place each time the vehicle is started and/or stopped or after a specified number of starting and/or stopping processes.

In this way, it is ensured that the current configuration of the vehicle is continuously transmitted to the receiving apparatus and stored in the storage device.

The system can comprise a vehicle configuration comparison apparatus which is installed in the vehicle and compares the currently determined configuration to a previously stored configuration and only then transmits the current component configuration if it is different from the previously stored component configuration. In this way, the amount of data transmitted is reduced to the extent necessary, and the costs and the energy consumption for an unnecessary transmission of data, which are already stored in the storage device, can be saved.

In one embodiment, the system is able to determine concrete installation positions of components in the vehicle. To this end, the installation position of a component installed in the vehicle ex-works can be stored as a datum in a data set associated with the component. If the component is replaced, the information at hand with regard to the installation location is transferred to the new component so that the installation location or the replacement component is subsequently known.

A plurality of data reading apparatuses can also be installed in the vehicle. In this case, the position of a memory element in the vehicle and thus the installation position of a component can be determined on the basis of different received signal intensities (“relative signal strength intensity”, RSSI) which occur at the various data reading apparatuses. This is then particularly possible if, as e.g. for the wheels, the number of the possible installation positions is limited so that a zone based locating (“zoning”) is possible. In such a case, a rough position determination of a memory element is sufficient in order to be able to associate said element with a zone and an installation position disposed in the zone.

A determination of the installation position by means of triangulation is also alternatively or additionally possible by means of a suitable evaluation of the received signal intensities of at least three data reading apparatuses.

### BRIEF DESCRIPTION OF THE DRAWINGS

The FIGURE shows a schematic view of an exemplary embodiment of a system according to the invention for detecting a component configuration of a vehicle 2, which comprises the type, number and/or identity of the components 41, 42, 43, 44 installed in the vehicle 2.

### DETAILED DESCRIPTION

A vehicle 2 comprises a plurality of components 41, 42, 43, 44, e.g. wheels or tires 41, 42, outside mirror 44, generator or injection pump 43, etc., on which a memory element 51, 52, 53, 54, which can be read in a wireless manner, is mounted. Each of the memory elements 51, 52, 53, 54 which can be read in a wireless manner can either be designed as a passive memory element 51, 52, 53, 54 which does without a separate energy supply, in particular as a RFID memory element, or as an active memory element 51, 52, 53, 54 which has a separate transmission unit and a separate energy supply, in particular an electrochemical battery or a rechargeable battery.

The data stored in the memory elements 51, 52, 53, 54 which can be read in a wireless manner also particularly comprise an identification number which is unambiguous for each component 41, 42, 43, 44 and which enables each memory element 51, 52, 53, 54 which can be read in a wireless manner and the component 41, 42, 43, 44 associated therewith be unambiguously identified.

The vehicle 2 is additionally equipped with a data reading apparatus 6 which is designed such that said apparatus is capable of reading in a wireless manner the data stored in the memory elements 51, 52, 53, 54 which can be read in a wireless manner and of sending said data to a vehicle transmission apparatus 8 which is likewise arranged in the vehicle 2.

The data reading apparatus 6 and the vehicle transmission apparatus 8 can, as shown in the drawing, be designed as separate elements or apparatuses. The two apparatuses 6, 8 can, however, also be integrated into a common data reading and transmission apparatus 6, 8.

The vehicle transmission apparatus 8 is designed to transmit data, which were transmitted to it by the data reading apparatus 6, e.g. via an antenna 10 that can be disposed inside or outside of the vehicle 2, for the purpose of transmitting said data to a receiving apparatus 12, which can likewise have an antenna 14 and is disposed in the immediate vicinity of the vehicle 2, in particular in a repair garage environment.

The data transmission can take place with the aid of electromagnetic waves outside of the optical domain (e.g. via Bluetooth®, WLAN, etc.) or within the optical domain, for example infrared light.

The transmission of data from the vehicle 2 to the receiving apparatus 12 can take place particularly via a mobile radio network suitable for data transmission and/or the internet. The data transmission can take place over a greater distance when using a mobile radio network and/or the internet; thus enabling the data transmission to be carried out at any time, in particular independently of repair shop visits, and gaps in the records can be avoided.

The receiving apparatus 12 is a constituent part of a workshop system 15 which also comprises an evaluation apparatus 24 which is designed to evaluate the data transmitted to the receiving apparatus 12, in particular to determine the type, the number and/or the identity of components 41, 42, 43, 44 installed in the vehicle 2.

In addition, the system also has at least one memory apparatus 16, which is designed to store component identification data which are associated with respectively one component, and a comparison unit 26 which is designed to compare the data transmitted to the receiving apparatus 12 with the component identification data sets stored in the memory apparatus 16 and to determine an identification data set which contains the data transmitted to the receiving apparatus 12 in order in this way to determine type, number and/or identity of the components 41, 42, 43, 44 installed in the vehicle 2.

The workshop system 15 can also additionally comprise a display device 18 and/or an input device 20 which enable the data stored in the memory apparatus 16 to be displayed, changed or enhanced.

In a preferred exemplary embodiment, the workshop system 15 additionally comprises a transmission apparatus 13. Furthermore, the vehicle 2 additionally comprises a vehicle receiving apparatus 9 which is designed to receive data that have been sent out by the transmission apparatus 13 and thus to also enable a transmission of data in the opposite direction, i.e. from the workshop system 15 to the vehicle 2 in addition to the transmission of data from the vehicle 2 to the workshop system 15.

The data transmission can take place with the aid of electromagnetic waves outside of the optical domain (e.g. via Bluetooth®, WLAN, etc.) or within the optical domain, which particularly comprises infrared light.

The transmission of data from the transmission apparatus 13 to the vehicle 2 can particularly take place via a mobile radio network suitable for data transmission and/or the internet.

The vehicle transmission apparatus 8 and the vehicle receiving apparatus 9 as well as the transmission apparatus 13 and the receiving apparatus 12 can also in each case be designed as a combined transmission and receiving apparatus.

The vehicle receiving apparatus 9 installed in the vehicle 2 is preferably connected to a vehicle or engine control unit 22 in order to enable data from the workshop system 15 to be transmitted to the vehicle or engine control unit 22 with the aid of the transmission apparatus 13 and the vehicle receiving apparatus 9. This makes it possible to change parameters of the vehicle respectively engine control unit 22, in particular on the basis of the components 41, 42, 43, 44 installed in the vehicle 2, and particularly to adapt said parameters to the components 41, 42, 43, 44 installed in the vehicle 2.

A vehicle respectively engine control unit software can particularly be read from a software memory 17 of the workshop system 15 and be transmitted via the transmission apparatus 13 and the vehicle receiving apparatus 9 to the vehicle respectively engine control unit 22 in order to operate said vehicle respectively engine control unit 22 with a suitable, in particular current, vehicle respectively engine control unit software. The vehicle respectively engine control unit software can thereby be selected particularly as a function of the component configuration of the vehicle 2, i.e. in particular the type, number and/or identity of the components 41, 42, 43, 44 installed in the vehicle 2, which was determined by the evaluation apparatus, in order to operate the vehicle respectively engine control unit 22 with a software optimally adapted to the current component configuration of the vehicle 2.

The software can particularly be updated if the type, number and/or identity of the components 41, 42, 43, 44 installed in the vehicle 2 have been changed and/or if an updated software is available in the software memory 17 of the workshop system 15 for the combination of the components 41, 42, 43, 44 currently installed in the vehicle 2.

The data reading apparatus 6 and the vehicle transmission apparatus 8 can be activated, for example by the vehicle control unit 22, at defined points in time, e.g. when starting and/or switching off the vehicle 2, in particular the engine of the vehicle, or at regular, temporal intervals, e.g. every day, every week or every month, and/or after a predefined number of start and/or stop processes in order to read the data from the memory elements 51, 52, 53, 54 installed in the vehicle 2 and to transmit said data from the vehicle transmission apparatus 8 to the workshop system 15.

The data sent out from the vehicle transmission apparatus 8 are received by the receiving apparatus 12 and passed on to the memory apparatus 16 and stored there. In this way, data are always stored in the memory apparatus 16 which exactly describe the current component configuration of the vehicle 2, i.e. in particular the type, number and/or identity of the components 41, 42, 43, 44 installed in the vehicle 2.

The memory apparatus 16 can, as shown in the drawing, be designed as a constituent part of the workshop system 15; however also as part of a “virtual data cloud” (“cloud”) which can be accessed via the internet.

If the data of the vehicle 2 are stored in a “virtual data cloud” (“cloud”), they are available at all locations at which an access to the internet is possible and can, as required, be quickly retrieved particularly in the case of a breakdown or repair.

The evaluation apparatus 24 can also additionally comprise a configuration comparison apparatus 25 which is designed to compare the currently transmitted configuration of a vehicle 2 with a configuration of the same vehicle 2 transmitted at an earlier point in time and stored in a configuration memory apparatus 27 and in this way to detect and, if applicable, display possible changes in the configuration of the vehicle 2.

Provision can also alternatively or additionally be made for a vehicle configuration comparison apparatus 7 comprising a local memory 7a. The local memory 7a is designed to store data which were read at a first point in time from at least one of the memory elements 51, 52, 53, 54 which can be read in a wireless manner; and the vehicle configuration comparison apparatus 7 is designed to compare data which were read at a second, later point in time from at least one of the memory elements 51, 52, 53, 54 which can be read in a wireless manner with the data stored in the local memory 7a which were read at a first, earlier point in time and only then to transmit data from the vehicle 2 to the workshop system 15 with the aid of the vehicle transmission apparatus 8 if the data read at the second, later point in time are different from the data stored in the local memory 7a. In so doing, unnecessary data transmissions can be avoided.

In addition, the current mileage of the vehicle 2 can also be read from the control unit 22 and be transmitted by the vehicle transmission apparatus 8 to the workshop system 15.

With the aid of the data transmitted from the vehicle 2 to the receiving apparatus 12, a “log book” of the vehicle 2, the configuration thereof and the components 41, 42, 43, 44 installed in the vehicle 2 can be fully automatically created in the memory apparatus 16 and kept up to date, in particular if the transmitted data also comprise the current mileage.

In this way, the configuration of the vehicle 2 can be traced at any time, in particular also in retrospect, and manipulations of the configuration of the vehicle 2 can be easily, reliably and quickly detected.

The data of the configuration of the vehicle 2 are available over the entire service life of the vehicle 2 an can, e.g., be used for the product development and/or processing in order to improve the product quality.

Because the components 41, 42, 43, 44 of the vehicle 2 can be individually identified with the system according to the invention and unambiguously associated with the vehicle 2, measured data of the vehicle 2 can easily be associated with the respectively affected component 41, 42, 43, 44 for the documentation of tests. As a result, tests of new components 41, 42, 43, 44 can be carried out more easily and faster than has previously been the case; and defective components 41, 42, 43, 44 can be quickly and reliably identified and pinpointed.

If, e.g., the sensors in the vehicle 2 determine that the injector in the first cylinder of the engine is defective, this information can be unambiguously associated with the affected injector because it is known which injector is installed in which cylinder and in particular which injector is installed in the first cylinder. Hence, the degree to which the affected injector has been stressed, the error pattern thereof, etc. can be associated with the respective injector and documented.

Up until now, the configuration of the components 41, 42, 43, 44 in the vehicle 2 had to be logged via manual parts lists for the documentation of vehicle respectively component tests. In so doing, the manual parts lists have to first be completely drawn up and manually kept up to date when components 41, 42, 43, 44 are replaced, which is time consuming and subject to error. Particularly if components 41, 42, 43, 44 have to be replaced during a test drive, e.g. because damage has occurred, it is not always ensured that the parts lists are promptly, correctly and completely updated.

Such errors can be eliminated by the use of the system according to the invention, by means of which the parts lists are automatically updated. In addition, the necessary software adaptation of the control unit (e.g. driver) can take place automatically during tests which are carried out after the installation of a new component 41, 42, 43, 44 by means of the online connection into the vehicle 2, as previously described. As a result, the effort and expense for a manual updating of the software are eliminated.

1. A system for detecting components (41, 42, 43, 44) of a vehicle (2), which comprises at least one component (41, 42, 43, 44), having:
at least one memory element (51, 52, 53, 54) which can be read in a wireless manner and is associated with at least one component (41, 42, 43, 44) of the vehicle (2);
at least one data reading apparatus (6) arranged in the vehicle (2) and which is configured to read data which are stored in the at least one memory element (51, 52, 53, 54) in a wireless manner;
at least one transmission apparatus (8) arranged in the vehicle (2) and which is configured to transmit the data which are read from the at least one data reading apparatus (6) to the at least one receiving apparatus (12);
a workshop system (15) which is configured to select a software for at least one control unit (22) of the vehicle (2) using the data read from the at least one memory element (51, 52, 53, 54) and transmitted to the receiving apparatus (12);
a transmission apparatus (13) which is configured to transmit the selected software in a wireless manner to the vehicle (2); and
a vehicle receiving apparatus (9) which is configured to receive selected software and to install said software in at least one control unit (22) of the vehicle (2).

2. The system according to claim 1, wherein the system additionally comprises an evaluation apparatus (24) which is designed to determine type, number and/or identity of the components (41, 42, 43, 44) installed in the vehicle (2) on the basis of the data transmitted to the receiving apparatus (12).

3. The system according to claim 2, wherein the system comprises: at least one memory apparatus (16) which is configured to store component identification data sets which are associated with respectively one component (41, 42, 43, 44) and one comparison unit (26) which is configured to compare the data transmitted to the receiving apparatus (12) with data in the component identification data sets and to identify at least one component identification data set which contains the data transmitted to the receiving apparatus (12) in order to determine type, number and/or identity of the components (41, 42, 43, 44) installed in the vehicle (2).

4. The system according to claim 1, wherein at least one memory element (51, 52, 53, 54) is a passive memory element (51, 52, 53, 54).

5. The system according to claim 1, wherein at least one memory element (51, 52, 53, 54) is an active memory element (51, 52, 53, 54).

6. The system according to claim 1, wherein the system additionally comprises at least one second transmission apparatus (13) which is disposed outside of the vehicle (2) and at least one vehicle receiving apparatus (9) is be disposed in the vehicle (2) and is designed to receive a signal transmitted from the second transmission apparatus (13).

7. The system according to claim 1, wherein the transmission and receiving apparatuses (8, 9, 12, 13) are designed to transmit the data per infrared light and/or electromagnetically, via a mobile radio network, WLAN, Bluetooth®, and/or via the internet.

8. The system according to claim 1, wherein the evaluation apparatus (24) additionally comprises a configuration comparison apparatus (25) which is configured to compare the data of the vehicle (2) currently read from the at least one memory element (51, 52, 53, 54) and transmitted to the receiving apparatus (12) with data of the same vehicle (2) read out at an earlier point in time from at least one memory element (51, 52, 53, 54) and transmitted to the receiving apparatus (12) in order to detect possible changes in the component configuration of the vehicle (2).

9. A vehicle (2), in particular a motor vehicle, which is equipped with a system according to claim 1 and with at least one component (41, 42, 43, 44) which is provided with a memory element (51, 52, 53, 54).

10. The vehicle (2) according to claim 1, wherein the system is set up such that data are read from at least one memory element (51, 52, 53, 54) disposed in or on the vehicle (2) and are sent out from the at least one transmission apparatus (8) at at least one predefined point in time.

11. The vehicle (2) according to claim 10 comprising a vehicle configuration comparison apparatus (7) which is configured to compare the data of the vehicle (2) currently read from the at least one memory element (51, 52, 53, 54) with data of the same vehicle (2) read and transmitted at an earlier point in time from at least one memory element (51, 52, 53, 54), and only then to transmit data from the vehicle (2) to the receiving apparatus (12) if the current configuration of the vehicle (2) is different from the configuration that was last transmitted.

12. A method for detecting components (41, 42, 43, 44) of a vehicle (2) which comprises at least one component (41, 42, 43, 44) with which a memory element (51, 52, 53, 54) that is read in a wireless manner is associated, wherein the method comprises:
reading data in a wireless manner from the at least one memory element (51, 52, 53, 54);
transmitting the read data to at least one receiving apparatus (12);
selecting a software for the at least one control unit (22) of the vehicle (2) using the data read from the at least one memory element (51, 52, 53, 54) and transmitted to the at least one receiving apparatus (12);
transmitting the selected software in a wireless manner to the vehicle (2); and
installing said software in at least one control unit (22) of the vehicle (2).

13. The method according to claim 12, which additionally further comprising
comparing the data transmitted to the receiving apparatus (12) with data in stored component identification data sets, which are associated with respectively one component (41, 42, 43, 44); and
identifying a component identification data set which contains the data transmitted to the receiving apparatus (12) in order to thus determine type, number and/or identity of the components (41, 42, 43, 44) installed in the vehicle (2).

14. The system according to claim 4, wherein the passive memory element (51, 52, 53, 54) is an RFID element.

15. The vehicle (2) according to claim 10, wherein the at least one predefined point in time is when starting and/or stopping an engine disposed in the vehicle (2).

16. The vehicle (2) according to claim 10, wherein the at least one predefined point in time is at predefined intervals.
